(19) United States
(12) Patent Application Publication
(10) Pub. No.: US 2007/0153979 A1
(43) Pub. Date: Jul. 5, 2007

(54) X-RAY SYSTEM HAVING AN X-RAY GENERATOR THAT PRODUCES AN X-RAY FOCAL SPOT WITH MULTIPLE INTENSITY MAXIMA

(76) Inventors: Joachim Baumann, Muenchen (DE); Martin Engelhardt, Muenchen (DE); Jorg Freudenberger, Eckental (DE); Thomas Mertelmeier, Erlanger (DE); Peter Schardt, Hochstadt A.D. Aisch (DE); Burkhard Schillinger, Garching (DE)

Correspondence Address: SCHIFF HARDIN, LLP;PATENT DEPARTMENT, 6600 SEARS TOWER, CHICAGO, IL, 60606-6473, US

(21) Appl. No.: 11/616,374

(22) Filed: Dec. 27, 2006

(30) Foreign Application Priority Data
Dec. 27, 2005 (DE) 10 2005 062 447.2

(51) Int. Cl. H01J 35/14

(52) U.S. Cl. 378/138

(57) ABSTRACT

A system for generation of an x-ray image with high resolution has an x-ray generator that produces an x-ray focal spot with a number of intensity maxima. The partial x-ray images corresponding to each of the intensity maxima are subsequently reconstructed into an x-ray image of high resolution using an algorithm taking into account the spatial distribution.

### BACKGROUND OF THE INVENTION

1. Field of the Invention

The present invention concerns an x-ray system that includes an x-ray generator that emits an x-ray beam that forms a focal spot at the anode of the x-ray generator.

2. Description of the Prior Art

It is generally known to generate x-ray radiation by electrons striking an anode. Due to the heat thereby created, the region of the anode in which the electrons are decelerated is known as a focal spot.

The image information of an x-ray image is fundamentally determined by the resolution and the signal/noise ratio. The resolution increases with decreasing size of the focal spot. The signal/noise ratio increases with increasing intensity of the x-ray radiation. For generation of an x-ray image with a large amount of image information, according to the prior art it is sought to generate an optimally high intensity of the x-ray radiation with an optimally small focal spot. A problem is that the anode material melts if the thermal load is excessive. In order to counteract this, the anode is cooled insofar is it is possible given the anode design. The thermal load also can be reduced by movement of the anode material relative to the focal spot. Anodes of the latter type are, for example, rotary anodes.

In comparison to stationary anodes, for rotary anodes it is useful to increase the applied electrical power (for instance by a factor of 10), while maintaining the same focal spot size. The rotary anode must be rotated with a high rotation speed in order to ensure a sufficiently short residence time of the focal spot on the anode material in order to avoid melting the material.

For generation of x-ray images with a further increased image information, one might consider further increasing the rotation speed of rotary anodes and to simultaneously reduce the size of the focal spot. A requirement for this would be the production of superlatively precision manufactured rotary anodes in which in the rotation a variation of the position of the focal spot is at most approximately 10% of the focal spot size. The manufacture of such rotary anodes is technically barely possible for focal spot sizes of less than 50 μm.

From the field of industrial x-ray engineering x-ray tubes are known in which the size of the focal spot lies in a range from 10 to approximately 0.5 μm. The intensity of the x-ray radiation generated with such a small focal spot is disadvantageously relatively low, due to the maximum tolerable thermal load of the anode. For generation of a single x-ray image with the desired image information, long exposure times in the range of 10 seconds are necessary in typical medical applications. A use of such x-ray tubes in the field of medical x-ray computed tomography would consequently require exposure times of 1.5 to 3 hours.

### SUMMARY OF THE INVENTION

An object of the present invention to overcome the disadvantages described above exhibited by prior art devices. In particular a system should be specified with which an x-ray image with improved image information can be produced with shortened exposure times.

This object is achieved in accordance with the invention by an x-ray system having an x-ray generator that produces an x-ray focal spot with a number of intensity maxima that cause an overall intensity distribution measurable behind an irradiated subject to be composed of superimposed intensity distributions, each of the intensity distributions corresponding to one of the intensity maxima.

Each intensity maximum in the focal spot generates an intensity distribution, i.e., a partial x-ray image of the irradiated subject, corresponding to the intensity maximum. Given multiple intensity maxima, multiple intensity distributions or partial x-ray images corresponding thereto result, the intensity distributions or partial x-ray images overlapping and being displaced slightly relative to one another. The superimposed intensity distributions form the overall intensity distribution. When the spatial distribution of the intensity maxima in the focal spot is known, an algorithm with which the displacements (dependent upon irregularities in the spatial distribution) of the superimposed partial x-ray images are corrected can be applied to the intensity measurement values reflecting the overall intensity distribution. The partial x-ray images are made congruent. Given shortened exposure times an x-ray image with improved resolution results, in particular improved depth resolution. For this purpose, a defined parameter, in particular a magnification factor can be input for each subject plane for reconstruction of the subject from the superimposed partial x-ray images. It is therewith possible (similar to as in digital tomosynthesis) to achieve a depth resolution that increases with increasing diameter of the focal spot.

The x-ray generator produces the intensity maxima with an arrangement that interacts with the electron beam. The arrangement is preferably fashioned such that a predetermined spatial distribution of the intensity maxima can be generated. The predetermined spatial distribution of the intensity maxima in the focal spot can be generated sequentially, for example. In this case the diameter of the electron beam corresponds to the average diameter of a focal spot. The electron beam can be deflected with high speed to cause the intensity maxima to be generated with the predetermined spatial distribution. In this case the intensity distributions or partial x-ray images corresponding to the intensity maxima can also be acquired in succession stored separately and later reconstructed into an x-ray image.

The spatial distribution of the intensity maxima can also be generated with a wide electron beam extending over the entire focal spot. In this case the predetermined spatial distribution of the intensity maxima can be generated by a recess provided on the anode. The recess can exhibit the form of a disc or at least a ring, advantageously a number of concentric rings.

The spatial distribution also can be generated by a corresponding distribution of a first anode material with an atomic number of more than 40 within or on a second anode material with an atomic number of less than 30. The first anode material serves for decelerating the electrons and thus for the generation of x-ray radiation. The second anode material serves for the dissipation of the heat generated in the first anode material. The first anode material can be, for example, tungsten, tantalum or alloys of these elements. The second anode material can be, for example, copper, molybdenum, diamond or the like.

According to a further embodiment, each intensity maximum is a discrete intensity maximum forming a focal point. The focal points in the focal spot are thereby appropriately spaced apart from one another such that heat zones forming around the focal spots due to lateral heat dissipation do not overlap or only slightly overlap.

The focal points can exhibit an average diameter in the range from 0.1 to 20 μm. The focal points are advantageously not regularly arranged in the focal spot. The entirety of the focal points or of the focal spot can exhibit an average diameter in the range from 1 to 100 μm.

According to a further embodiment of the invention, a measurement device is provided for measurement of a spatial distribution of an intensity of the x-ray radiation radiated from the focal spot. In this variant, for example, an initially unknown spatial distribution of the intensity maxima is generated in the focal spot. The spatial distribution is then measured with the measurement device and can subsequently be taken into account in the reconstruction of the x-ray image.

The inventive system appropriately also has a detector for spatially-resolved measurement of the total intensity distribution that can be detected behind the irradiated subject. For example, this can be a digital detector with a number of intensity measurement elements arranged in a surface. The inventive device can also include a reconstruction device for mathematical reconstruction of the x-ray image by the use of an algorithm (which algorithm takes into account the spatial distribution) to the intensity measurement values reflecting the total intensity distribution. The reconstruction device is in practice appropriately a computer with a suitable program that enables the reconstruction of the x-ray image using the algorithm.

The provision of a number of focal points in the focal spot enables the generation of x-ray images with an excellent resolution and a very good signal/noise ratio.

Given a fixed anode, a conventional focal spot with a diameter of 10 μm normally exhibits an x-ray intensity that corresponds to an electrical power on the order of approximately 10 W (given a tungsten anode). An inventive focal spot with 10 focal points which respectively exhibit a diameter of 1.0 μm can be exposed with one waft. The same x-ray intensity thus results, but with a resolution that is ten times higher. For example, using the inventive device it is possible (for example given the phase contrast technique according to Christian David) to increase the intensity and therewith to improve the signal/noise ratio.

The algorithm can be a convolution or deconvolution algorithm. The algorithm can be based on Fourier transformation. The use of the Richardson-Lucy algorithm or a maximum entropy algorithm is also suitable. Both the Richardson-Lucy algorithm and maximum entropy algorithms are also suitable for reconstruction of x-ray images in which the total intensity distribution has been generated using anodes with surfaces which are not parallel to the detector. The reconstruction of the x-ray image advantageously occurs by digital calculation operations. For reconstruction of the x-ray image it is required that the spatial distribution in the focal spot be known. For this a predetermined spatial distribution can be generated or an initially unknown spatial distribution can be measured. Naturally it is also possible to generate a predetermined spatial distribution and additionally to measure the generated spatial distribution.

### DESCRIPTION OF THE DRAWINGS

FIG. 1 is a schematic block diagram of a device for generation of high-resolution x-ray images.

FIG. 2 is a schematic cross-section of a portion of a first embodiment of a rotary anode in accordance with the invention.

FIG. 3 is a schematic cross-section of a portion of a second embodiment rotary anode in accordance with the invention.

FIG. 4 is a schematic cross-section of a portion of a third embodiment of a rotary anode in accordance with the invention.

FIG. 5 is a schematic partial cross-section of a portion of a fourth embodiment of a rotary anode in accordance with the invention.

FIG. 6 is a schematic cross-section of a portion of a fifth embodiment of a rotary anode in accordance with the invention.

FIG. 7 is a schematic cross-section of a portion of a sixth embodiment of a rotary anode in accordance with the invention

FIG. 8 schematically illustrates the generation of partial x-ray images in accordance with the invention.

FIG. 9a shows a test pattern.

FIG. 9b shows a measured total intensity distribution of the test pattern according to FIG. 9a.

FIG. 9c shows an x-ray image after mathematical deconvolution of the measured total intensity distribution according to FIG. 9b.

### DESCRIPTION OF THE PREFERRED EMBODIMENTS

FIG. 1 schematically shows a system for generation of an x-ray image with high resolution. A focal spot 1 (indicated with the broken line) is composed of a number of irregularly-arranged focal points 2. In the described example the focal points 2 can exhibit an average diameter in the range from 0.5 to 5 μm and are spaced apart from one another such that a heat zone forming around each of the focal points 2 does not overlap or only insignificantly laterally overlaps with an adjacent heat zone. A foil which is nearly completely (i.e. up to 99%) permeable for x-rays is designated with the reference character 3. The foil exhibits a hole 4, but instead of the hole 4 a spot can be provided that exhibits a slightly lower transparency (for example 98%) than the foil 4.

A measurement chamber for acquisition of a spatial distribution of the focal spot 1 provided by the focal points 2 is designated with the reference character 5. The measurement chamber 5 is fashioned such that it does not form a shadow. A subject 6 to be irradiated and a detector 7 for acquisition of a total intensity distribution escaping from the subject 6 are arranged in the beam path after the measurement chamber 5. The total intensity distribution measured with the detector 7 is acquired (advantageously in digitized form) with a computer connected with the detector. The computer 8 is also connected with the measurement chamber 5 for acquisition (advantageously in digitized form) of a spatial distribution of the focal spot 1 measured with this. The computer 8 executes a program for mathematical reconstruction of an x-ray image from the measured total intensity distribution as well as from the spatial distribution. The mathematical reconstruction ensues according to the principle of deconvolution of the total intensity distribution with the known spatial distribution. An x-ray image reconstructed with this can be shown on a monitor 9 connected with the computer 8.

A (possibly randomly generated) spatial distribution of the intensity in the focal spot 2 is measured with the device shown in FIG. 1 by means of the measurement chamber 5 and is known as a result of this.

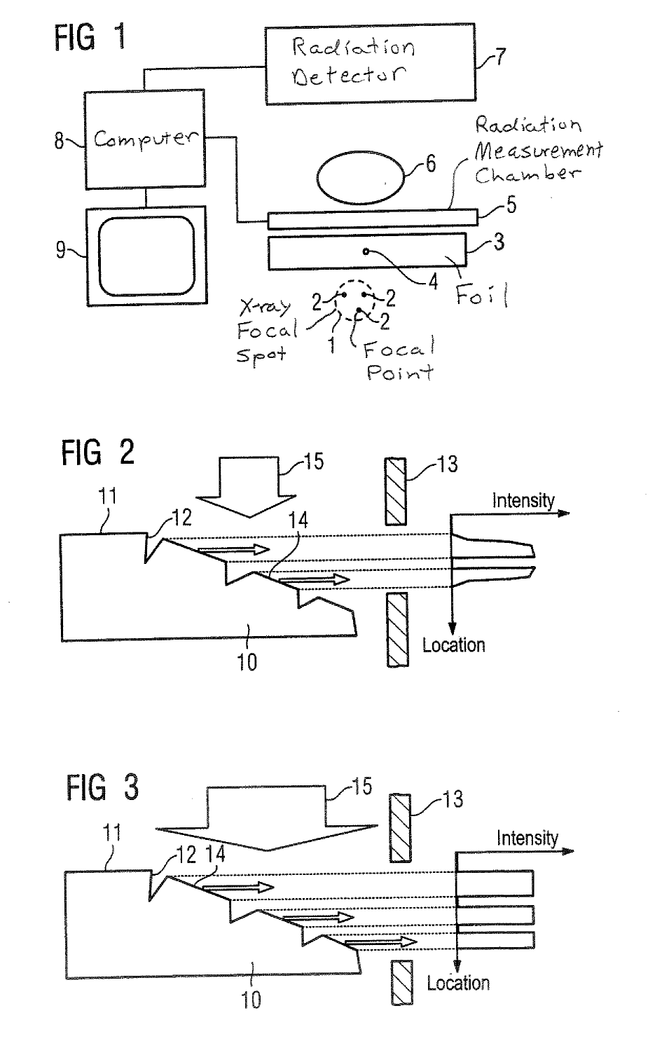

FIG. 2 through 7 show various arrangements for generation of a predetermined and thus known spatial distribution. For these arrangements it is not absolutely necessary to additionally measure the spatial distribution, but it is advantageous to do so.

FIG. 2 shows a schematic cross-section of a portion of an anode plate 10 of a rotary anode. The anode plate 10 comprises a number of circumferential recesses 12 on its top side 11 facing a cathode (not shown). The recesses 12 are fashioned such that x-ray radiation generated there is not or is only insignificantly radiated in the direction of an x-ray window 13. Circumferential elevations 14 are provided between the recesses 12. In contrast to the recesses 12, the elevations 14 are fashioned such that x-ray radiation generated there is radiated through the x-ray window 13. From the intensity distribution over the location shown to the right next to the x-ray window 13, a focal spot occurs with a number of intensity maxima or focal points, generated by the recess 12 on the top side 11 of the anode plate 10. The intensity maxima here respectively exhibit a steeply sloping edge [flank] and an obliquely sloping edge which is dependent on the width of the electron beam 15 used for generation of the x-ray radiation. The electron beam 15 exhibits an average diameter which corresponds to approximately the diameter of the focal spot 1.

Seen together with FIG. 3 it is apparent that a rectangular intensity distribution with the same relief can be generated given the use of a wide electron beam. The use of a focus with a rectangular intensity distribution enables an increase of the spatial resolution.

Instead of a single electron beam 15, it is also possible to use a number of electron beams 15a through 15c for generation of a number of intensity maxima.

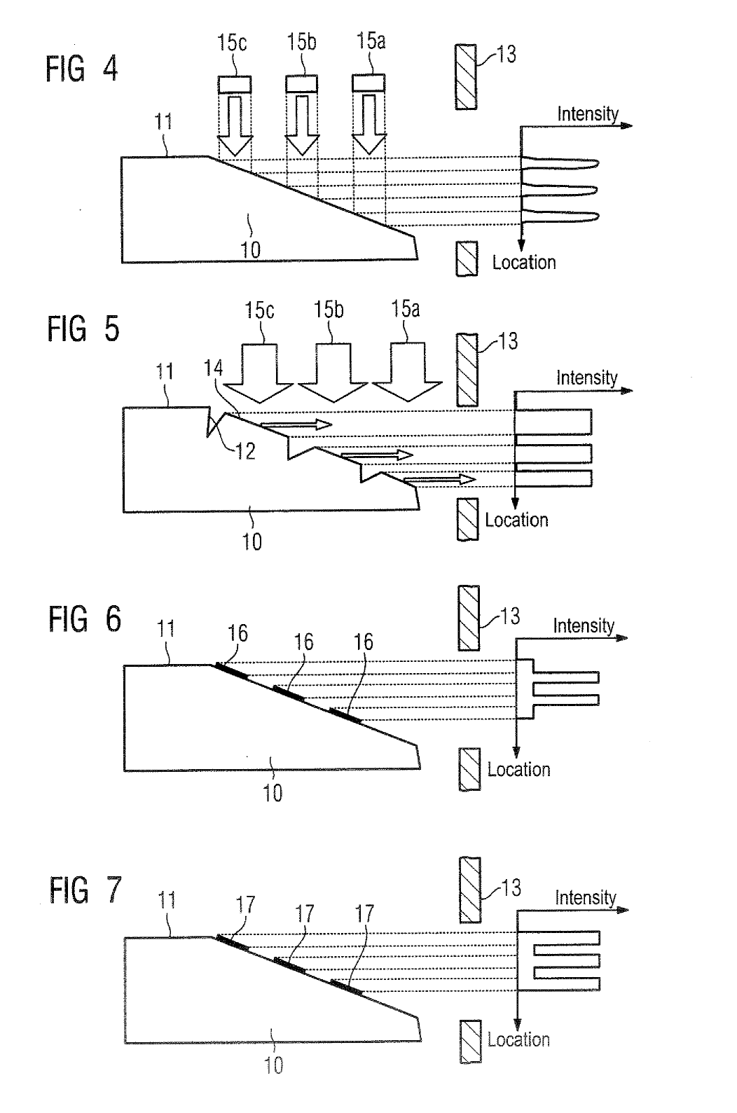

FIG. 4 shows a cross-section of a portion of an anode plate 10 that exhibits a smooth surface 11 in a conventional manner. For generation of a number of intensity maxima the surface 10 is charged with a number of discrete electron beams 15a through 15c. Instead of the number of discrete electron beams 15a through 15c shown here, a single discrete electron beam can also be used which is deflected within the focal spot 1 for generation of the intensity maxima. The discrete electron beams 15a through 15c shown here exhibit an average diameter which corresponds to approximately the average diameter of the intensity maxima.

FIGS. 6 and 7 show further possibilities of the production of a focal spot 1 with a number of intensity maxima or focal points. In the rotary anode shown in FIG. 6 the anode plate 10 has a first anode material that decelerates electrons with a high effective cross-section. The first anode material can be, for example, tungsten, tantalum or the like. A number of circumferential rings 16 are applied on the top side 11, the circumferential rings being produced from a second anode material. The second anode material is a material with a low atomic number that decelerates electrons only insignificantly and as a consequence of this radiates no or only a little x-ray radiation. For example, this can be a ceramic, for example Al₂O₃ or the like. The intensity distribution over the location shows that a focal spot 1 with a number of intensity maxima can likewise be generated with the proposed combination of different anode materials.

In the exemplary embodiment shown in FIG. 7 the anode plate 10 is formed of the second anode material with a low atomic number, i.e. a material that only insignificantly decelerates electrons and consequently radiates no or only slight x-ray radiation. This can in particular be a material with a high heat conductivity, for example molybdenum, copper or the like. A number of further circumferential rings 17 are located on the top side 11 of the anode plate 10, the rings 17 being produced from the first anode material with a high atomic number. This material decelerates electrons with a high effectiveness and consequently radiates x-ray radiation. It can thereby be, for example, tungsten, tantalum or the like. A focal spot 1 with a number of discrete intensity maxima 2 can also be generated with this.

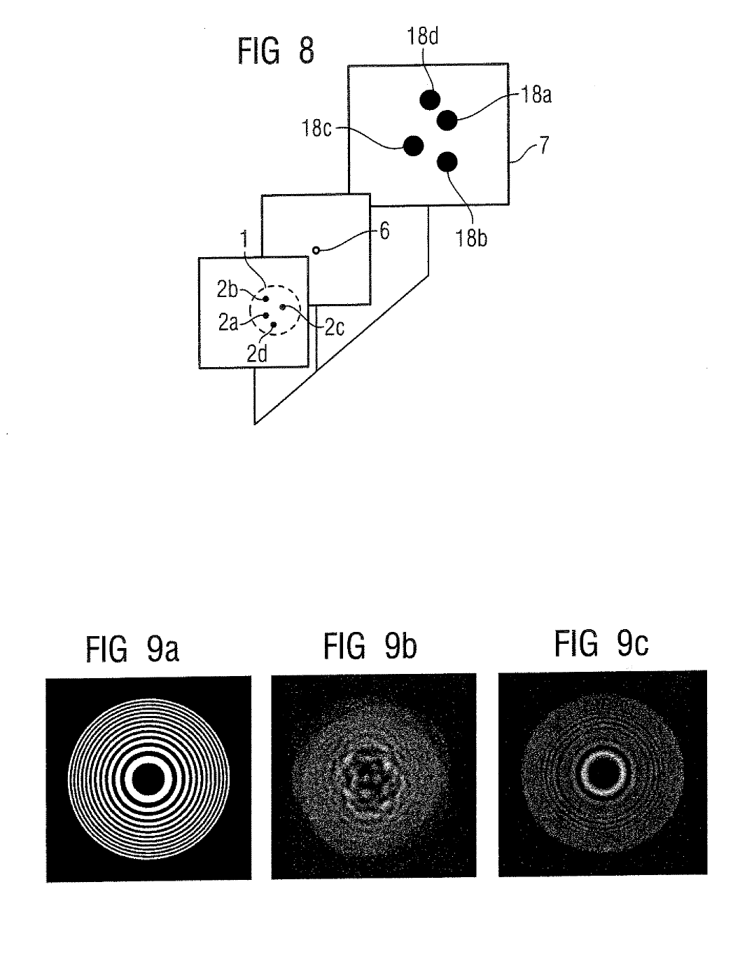

FIG. 8 schematically shows the basic operation of the inventive system. A subject 6 is irradiated with x-ray radiation which emanates from a focal spot 1 with a number of focal points 2a through 2d. Each of the focal points 2a through 2d generates on the detector 7 a partial x-ray image 18a through 18d corresponding to said focal point. The partial x-ray images 18a through 18d are superimposed. The partial x-ray images 18a through 18d are made congruent by a subsequent mathematical deconvolution of the total intensity distribution measured on the detector 7.

FIG. 9a through 9c show a result of a reconstruction. FIG. 9a is thereby a test pattern comprising concentric circles. FIG. 9b shows a total intensity distribution measured on the detector 7, which total intensity distribution has been measured using focal spot with a number of focal points 2. It can be seen that the total intensity distribution comprises a superimposition of a number of partial x-ray images 18a through 18d.

FIG. 9c shows the result of the mathematical deconvolution of the measured total intensity distribution according to FIG. 9b. The deconvolution has occurred according to a Richardson-Lucy algorithm or another conventional method by means of Fourier analysis and using the known spatial distribution of the intensity maxima 2 in the focal spot 1.

For the mathematical reconstruction of the x-ray image, exemplary reference is made to:
Peter A. Jannson (ed.): “Deconvolution of Images and Spectra”, Second Edition, Academic Press, London, 1997 (out of print, but available in libraries, contains a great deal of information regarding diverse algorithms);
S. F. Gull, J. Skilling: “Quantified Maximum Entropy MemSys5 User's Manual”, S. F. Gull, J. Skilling [sic], Maximum Entropy Data Consultants Ltd., South Hill, 42 Southgate street, Bury St. Edmungs, Suffolk, IP33 2AZ, U.K., http://www.maxent.co.uk (regarding maximum entropy);
E. Caroli, J. B. Stephen, G. Di Cocco, L. Nataluccci, A. Spizzinicho: “Coded Aperture Imaging in X- and Gamma Ray Astronomy”, Space Science Reviews 45 (1987) 349-403, (description of the convolution operation by means of matrix multiplication; reconstruction via inverse matrix which one obtains by rearranging the convolution matrix);
C. B. Wunderer: “Imaging with the Test Setup for the CodedMask INTEGRAL Spectrometer SPI”, dissertation, Technische Üniversitat München, Garching at Munich, 30 Jan. 2003.

The last-cited article passage concerns a similarly suitable mathematical reconstruction method in which the partial x-ray images displaced counter to one another can be superimposed by means of correlation.

Although modifications and changes may be suggested by those skilled in the art, it is the intention of the inventors to embody within the patent warranted hereon all changes and modifications as reasonably and properly come within the scope of their contribution to the art

We claim as our invention:

1. An x-ray system comprising:
an x-ray generator comprising an anode and an electron emitter that emits an electron beam directed onto the anode, said anode having a focal spot thereon in which electrons in said electron beam are decelerated and produce x-ray radiation; and
said x-ray generator comprising an arrangement that interacts with said electron beam to produce a plurality of intensity maxima in said focal spot, to produce an overall intensity distribution, behind a subject irradiated with said x-ray radiation, that comprises a plurality of superimposed intensity distributions respectively produced by the intensity maxima in said focal spot.

2. An x-ray system as claimed in claim 1 wherein said arrangement produces a predetermined spatial distribution of said intensity maxima in said focal spot.

3. An x-ray system as claimed in claim 2 wherein said arrangement comprises a recessed profile at a surface of the anodes facing said electron emitter.

4. An x-ray system as claimed in claim 3 wherein said recessed profile comprises an annular recess in said surface of said anode.

5. An x-ray system as claimed in claim 3 wherein said profile comprises a plurality of concentric annular recesses in said surface of said anode.

6. An x-ray system as claimed in claim 2 wherein said arrangement comprises a distribution of material in said anode comprising a first anode material with an atomic number of more than 40 distributed within a second anode material with an atomic number of less than 30.

7. An x-ray system as claimed in claim 2 wherein said arrangement comprises a distribution of material in said anode comprising a first anode material with an atomic number of more than 40 distributed on a second anode material with an atomic number of less than 30.

8. An x-ray system as claimed in claim 1 wherein said arrangement produces said plurality of intensity maxima as a plurality of discrete intensity maxima respectively forming focal points within said focal spot.

9. An x-ray system as claimed in claim 8 wherein said arrangement produces said focal points with respective diameters in a range between 0.1 and 20 μm.

10. An x-ray system as claimed in claim 8 wherein said arrangement produces said focal points in a non-regular spatial distribution within said focal spot.

11. An x-ray system as claimed in claim 8 wherein said arrangement generates said focal points within a focal spot having a diameter in a range between 1 and 100 μm.

12. An x-ray system as claimed in claim 1 comprising a measurement device disposed to measure a spatial distribution of intensity of said x-ray radiation radiated from said focal spot.

13. An x-ray system as claimed in claim 1 comprising a detector disposed behind said subject that produces a spatially-resolved measurement of said overall intensity distribution.

14. A device as claimed in claim 13 comprising an image reconstruction computer that reconstructs an image of the subject from said overall intensity distribution using an algorithm that generates said image dependent on said spatially-resolved measurement.

15. An x-ray system as claimed in claim 14 wherein said computer is configured to execute an algorithm for generating said image selected from the group consisting of convolution algorithms, deconvolution algorithms, and maximum entropy algorithms.

16. An x-ray system as claimed in claim 1 wherein said anode is a rotary anode.
